(19) United States
(12) Patent Application Publication
(10) Pub. No.: US 2024/0338591 A1
(43) Pub. Date: Oct. 10, 2024

(54) UNBIASED MACHINE LEARNING AND OFF-POLICY EVALUATION IN THE PRESENCE OF BIASED FEEDBACK

(71) Applicant: International Business Machines Corporation, Armonk, NY (US)

(72) Inventors: Matthew Richard Arnold, Carmel, NY (US); Benjamin Tyler Elder, Hawthorne, NY (US); Zach Shu, Malden, MA (US); Mohammadreza Fazeli, Toronto (CA)

(21) Appl. No.: 18/131,354

(22) Filed: Apr. 5, 2023

(51) Int. Cl. G06N 20/00

(52) U.S. Cl. CPC G06N 20/00

(57) ABSTRACT

Option exploration of one or more candidate options is performed in response to a user interaction. A multiplicative inverse of a propensity of showing each of the one or more candidate options to a user is computed and a multiplicative inverse of a propensity of each of the one or more candidate options being able to receive feedback is computed. An overall cost is computed by multiplying the multiplicative inverse of the propensity of showing each of the one or more candidate options by the multiplicative inverse of propensity of each of the one or more candidate options being able to receive feedback. The overall cost is applied as a weight to a corresponding sample.

### BACKGROUND

The present invention relates generally to the electrical, electronic and computer arts and, more particularly, to machine learning, neural networks, and artificial intelligence.

Artificial intelligence assistants use machine learning models to generate responses to a user's statements, requests, questions, and the like and are moving in the direction of automated learning over supervised learning. Machine learning assistants, such as chatbots, often present one or more choices in response to user input. As the machine learning assistant evolves during chat sessions, it might learn to disambiguate user input, such as responses, questions, statements and the like, based on user feedback, such as previous “clicks” (selections, responses, and the like) from earlier user interactions.

### BRIEF SUMMARY

Principles of the invention provide techniques for unbiased learning and off-policy evaluation in the presence of biased feedback. In one aspect, an exemplary method includes the operations of performing, using a hardware processor, option exploration of one or more candidate options in response to a user interaction; computing, using the hardware processor, a multiplicative inverse of a propensity of showing each of the one or more candidate options to a user; computing, using the hardware processor, a multiplicative inverse of a propensity of each of the one or more candidate options being able to receive feedback; computing, using the hardware processor, an overall cost by multiplying the multiplicative inverse of the propensity of showing each of the one or more candidate options by the multiplicative inverse of propensity of each of the one or more candidate options being able to receive feedback; and applying, using the hardware processor, the overall cost as a weight to a corresponding sample.

In one aspect, a computer program product comprises one or more tangible computer-readable storage media and program instructions stored on at least one of the one or more tangible computer-readable storage media, the program instructions executable by a processor, the program instructions comprising performing option exploration of one or more candidate options in response to a user interaction; computing a multiplicative inverse of a propensity of showing each of the one or more candidate options to a user; computing a multiplicative inverse of a propensity of each of the one or more candidate options being able to receive feedback; computing an overall cost by multiplying the multiplicative inverse of the propensity of showing each of the one or more candidate options by the multiplicative inverse of propensity of each of the one or more candidate options being able to receive feedback; and applying the overall cost as a weight to a corresponding sample.

In one aspect, a system comprises a memory and at least one processor, coupled to the memory, and operative to perform operations comprising performing option exploration of one or more candidate options in response to a user interaction; computing a multiplicative inverse of a propensity of showing each of the one or more candidate options to a user; computing a multiplicative inverse of a propensity of each of the one or more candidate options being able to receive feedback; computing an overall cost by multiplying the multiplicative inverse of the propensity of showing each of the one or more candidate options by the multiplicative inverse of propensity of each of the one or more candidate options being able to receive feedback; and applying the overall cost as a weight to a corresponding sample.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improve the technological process of computerized machine learning by removing bias in propensity weighting created by the presence of non-random missing user feedback, thereby creating machine learning models that provide improved accuracy;
improve the technological process of computerized machine learning by using a second layer of exploration (referred to herein as “feedback intervention”) to ensure that additional click data is obtained where user feedback is missing or where an insufficient amount of feedback is obtained (due, for example, to the sparse exploration of alternative options while presenting single answers); and
an improved counterfactual evaluator that compensates for missing user feedback data and bias in propensity weighting created by the presence of non-random missing user feedback.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIGS. 1 and 2 show an example of a conventional conversation between a user and an artificial intelligent (AI) assistant;

FIG. 3 is a conventional table for understanding the relevance of different options to consider for presentation to a user;

FIG. 4 is a table showing the confidence score and probability of being shown for six choices (A-F);

FIG. 5 illustrates two AI responses to a user statement, in accordance with an example embodiment;

FIG. 6 is a table showing the confidence score, a probability of being shown, and a probability of being clickable for six choices (A-F), in accordance with an example embodiment;

FIG. 7 is a workflow of an example evaluation system for machine learning models, in accordance with an example embodiment;

FIG. 8 illustrates the set of data points with missing feedback changes based on an example algorithm, in accordance with an example embodiment;

FIG. 9 is an example flowchart, in accordance with an example embodiment; and

FIG. 10 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Generally, methods and systems for providing unbiased machine learning and off-policy evaluation in the presence of biased feedback are disclosed. Machine learning assistants (referred to herein as ML assistants and artificial intelligence (AI) assistants), such as chatbots, often present one or more choices in response to user input. As the machine learning assistant evolves during chat sessions, it may learn to disambiguate user input, such as responses, questions, statements, and the like, based on user feedback, such as previous “clicks” (selections, responses, and the like; for example, using a mouse or other pointing or input/output device) from earlier user interactions. (While the present embodiments are described in the case where feedback is in the form of clicks, the use of a variety of different types of user feedback is contemplated.)

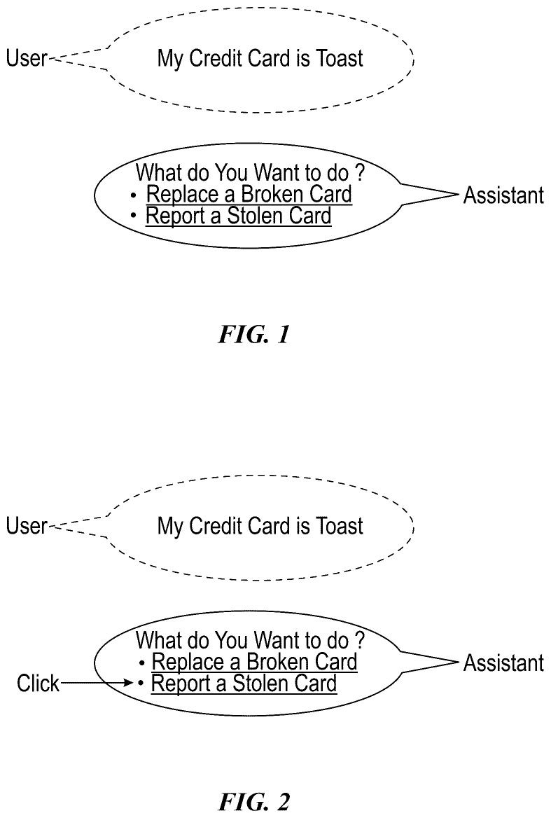

FIGS. 1 and 2 show an example of a conventional conversation between a user and an artificial intelligent (AI) assistant. In the example of FIG. 1, a user submits a statement (“My credit card is toast”) and the AI assistant processes the statement and provides a number of options (choices) to the user (such as, for example, a selection of up to five different options). As illustrated in FIG. 2, the user selects the most appropriate option (such as “Report a stolen card”). The AI assistant learns from the user selection of the presented choices which option or options are most appropriate to present in future conversations with the same user and/or another user in response to the same or similar user input. An example problem setting in this context is best described as: “Learning to rank with variable length lists.” It is worth noting that standard “bandits,” as known from the prior art, typically make decisions one action at a time; in particular, they choose to either explore or exploit known good actions one at a time. Furthermore, standard “learning to rank approaches,” as known from the prior art, typically always show the same number of choices (e.g., search results typically always show the same number of links per page). In contrast, one or more embodiments advantageously change the number of actions taken (suggestions shown) based on how confident the model is. It is worth noting that in some instances, some embodiments could be configured to handle one action at a time.

### Selection Bias

Systems (such as bandits, reinforcement learning (RL) systems, and the like) that learn from a feedback signal, such as the above described selection by the user, have a risk of being biased if they do not account for selection bias. As will be appreciated by the skilled artisan, the multi-armed bandit problem is a problem in which a fixed, limited, set of resources are to be allocated between competing (alternative) choices in a way that maximizes their expected gain, when each choice's properties are only partially known at the time of allocation, and may become better understood as time passes or by allocating resources to the choice. Selection bias is the well-known phenomenon that more feedback is received on choices favored by the trained machine learning model, and less (possibly zero) feedback is received on choices ranked poorly by the trained model. Selection bias can cause the model, as it continuously trains, to never converge on the true answer.

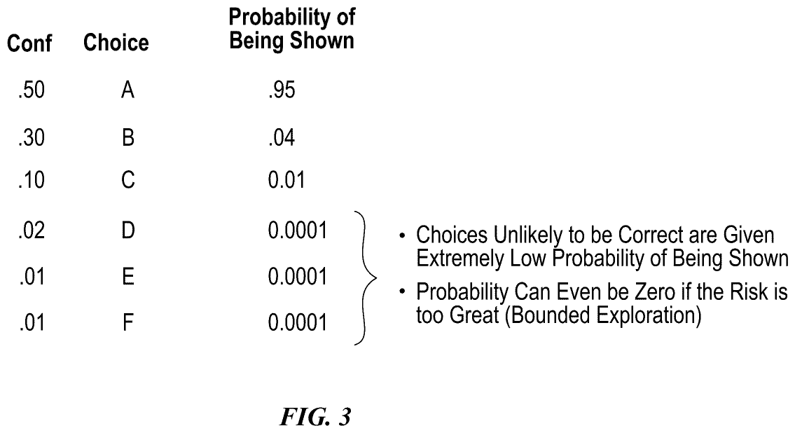

FIG. 3 is a conventional table for understanding the relevance of different options to consider for presentation to a user (there can sometimes be multiple “correct” answers). As illustrated in FIG. 3, six choices (A-F) are considered. A confidence score Conf is listed for each choice. Confidence scores may be calculated as estimates of several related quantities, such as a chance of the option being the correct option, a chance of the option being clicked, and the like. For example, choice A has a confidence score of 0.50. In some instances, it is possible to adjust the model so that a 50% confidence equals a 50% chance of being clicked, but this is not necessarily always the case. Choice B has a confidence score of 0.30, or a 30% chance of being correct. In one example embodiment, the confidence scores are generated by the machine learning model that is being trained by the obtained user feedback, such as “clicks.” A confidence level is typically understood to be the numerical score outputted by a machine learning model when making a prediction for a given input question/context and a given action. The confidence scores for multiple actions may be computed separately or all at the same time. It is also possible to assign scores without a machine learning model using, for example, rules, keyword matching, and the like.

It is noted that, dependent on the context, the sum of the probability of each choice being presented may be greater than 1.0. Typically the confidences will still sum to 1.0. Thus, it is noted that, dependent on the context, the sum of the per-choice probabilities of being shown may be greater than 1.0, if more than one choice can be presented at a time.

There are a variety of techniques for determining the probability of an option being shown (propensity). In general, the probability of being shown depends on the exploration method used to select answers; the probabilities are calculated to accurately reflect this method. In one example embodiment, if the method was to choose one out of N possible choices completely at random each time, then the probability for each choice would be 1/N. In one example embodiment, the confidences (which add to one) are viewed as a probability distribution; the probability distribution is sampled a fixed number of times (such as three times) WITH replacement. If three distinct choices are chosen, all three options are presented; if one choice is chosen twice (such that only two distinct choices were picked), then only two options are shown; and if the same choice is selected three times, then the option is shown by itself.

The subset of choices presented is typically based on the confidence score, but may not be strictly presented in proportion to the confidence score, as described more fully below. As illustrated in FIG. 3, the probability of choice A being presented is 0.95, meaning that choice A is one of the one or more options presented to a user 95% of the time. Again, it is noted that, dependent on the context, the sum of the per-choice probabilities of being shown may be greater than 1.0, if more than one choice can be selected at a time.

As illustrated in FIG. 3, some choices have extremely low confidence scores and are more likely an incorrect option to present. Depending on the tolerance of the user to the presentation of irrelevant choices, a threshold may be selected below which the choice is not presented. For example, if users are generally tolerant of irrelevant responses, the threshold may be set to a confidence score of 0.02, meaning the choice must have at least a 2% estimated chance of being correct to be presented whereas, if users are generally intolerant of irrelevant responses, the threshold may be set to a confidence score of 25 or 0.5, (meaning the choice must have at least a 25% estimated chance or 50% chance of being correct to be presented). These percentages are exemplary and other embodiments could have different values. Given the teachings herein, the skilled person can heuristically develop suitable thresholds for a given domain. In any case, even if the confidence score is above the threshold, the option is only presented at a rate corresponding to the probability of being shown (as illustrated in column three of the table of FIG. 3).

### Selection Bias

Selection bias is commonly mitigated by performing exploration (randomization) combined with propensity-weighted training. Propensity is basically a probability, such as the probability that a choice will be presented to a user, the probability that a choice will be presented to a user in a clickable form, and the like. In general, propensities are required for model training, cost-sensitive classification, and off-policy/counterfactual analysis (inverse propensity score (IPS)), and the like.

Propensity-weighted training upweights the importance of rare events. For example, a rarely used option may be randomly presented to a user while exploring the effectiveness of rarely used options. If positive feedback is received from the user for the randomly-presented option, the propensity-weight of the option (such as the probability of being presented) should be increased to ensure that the option receives the appropriate attention weighting. This serves to remediate the above-described selection bias.

### Exploration

As described above, there are a variety of reasons why potentially relevant choices are never presented to users. For example, the initial training of a model may result in the option having such a low confidence score (or no determined confidence score) that it is effectively never presented. Therefore, during feedback training, the option is never appropriately considered by the model. Exploration refers to the testing of choices that would otherwise be dismissed, overlooked, or otherwise excluded from presentation to a user. For example, a choice may be tested (included in a set of options presented to a user) in instances where the choice being tested would conventionally not be presented. There are a variety of known conventional algorithms for performing exploration, such as epsilon greedy where options are randomly added to the choices presented to the user at a small rate (epsilon), such as 1% or 0.1%. In real world applications, however, exploration typically needs to be applied more judiciously. For example, showing very irrelevant answers may do harm as, for example, it can reduce user's confidence in the AI assistant. A common method for mitigating risk during exploration is to explore options proportional to the likelihood of the option being correct based on the confidence score, i.e., the worse an answer looks in terms of the confidence score, the less often it should be presented.

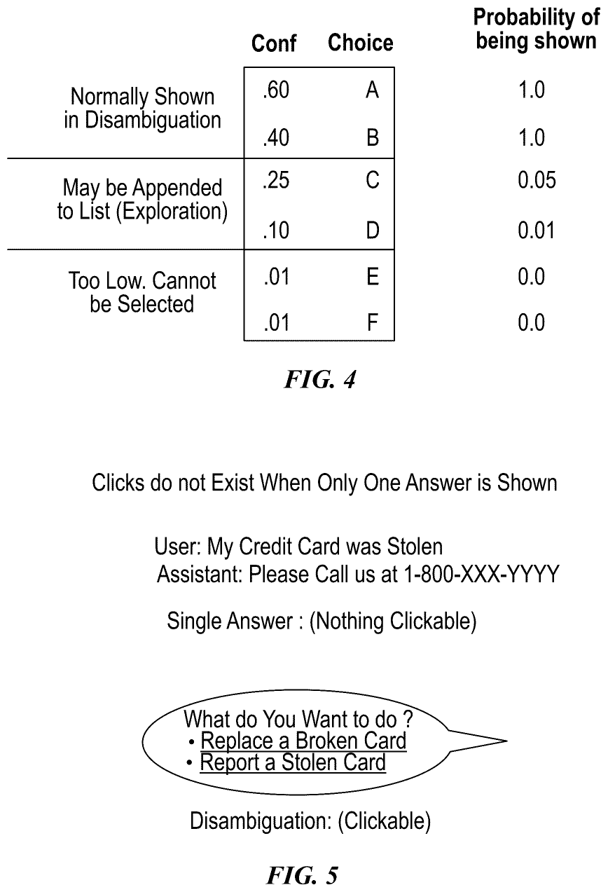

FIG. 4 is a table showing the confidence score and probability of an option being shown for six choices (A-F). The confidence score of choices A and B are so high (0.60 and 0.40, respectively) that they are presented 100% of the time. Choices unlikely to be correct are given extremely low probabilities of being shown. The probability can even be set to zero if the risk of harm is too great (known as bounded exploration). For example, choices E and F have confidence scores of 0.1 and, in some applications, are too low to even consider for presentation (thus, the probability of being shown is 0%).

In one example embodiment, exploration is performed by occasionally adding one additional choice to the set of choices (if the maximum number of choices was to be shown, the last choice is replaced with the new choice under test). As illustrated in FIG. 4, choices C and D, which may always be excluded in normal processing, are appended to the list as part of exploration. In the example of FIG. 4, choices C and D are presented 5% and 1% of the time, respectively. (The exploration is thus guided by the corresponding confidence vector.) It is noted that the choice of whether or not to append answers can be made probabilistically, weighted by the confidence scores of the answers already chosen to be shown and the ones not chosen. A high confidence answer is one that the model believes could be a relevant choice, so this makes it more likely to show answers the model believes are relevant options (“good”), and less likely (but not impossible) to show options that the model thinks are less relevant choices (“bad”).

### Challenge for Exploration and Propensities in AI Assistants

FIG. 5 illustrates two candidate AI responses to a user statement, in accordance with an example embodiment. As illustrated in FIG. 5, a user has submitted the statement “My credit card was stolen.” If the AI assistant only presents a single statement or answer in response (such as “Please call”), no feedback is obtained from the user as a “clickable” option does not exist. On the other hand, when a plurality of options (such as “Replace a broken card” or “Report a stolen card”) are presented by the AI assistant, disambiguation exists. In the latter case, “clickable” options may be provided and user feedback regarding the most relevant option may be obtained by the AI assistant.

### Challenge for Exploration and Propensities in AI Assistants

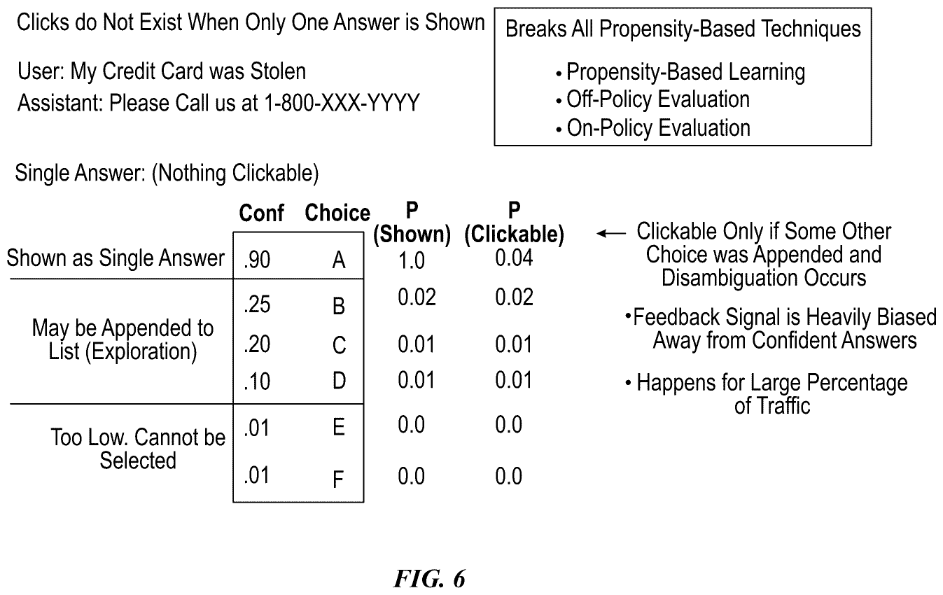

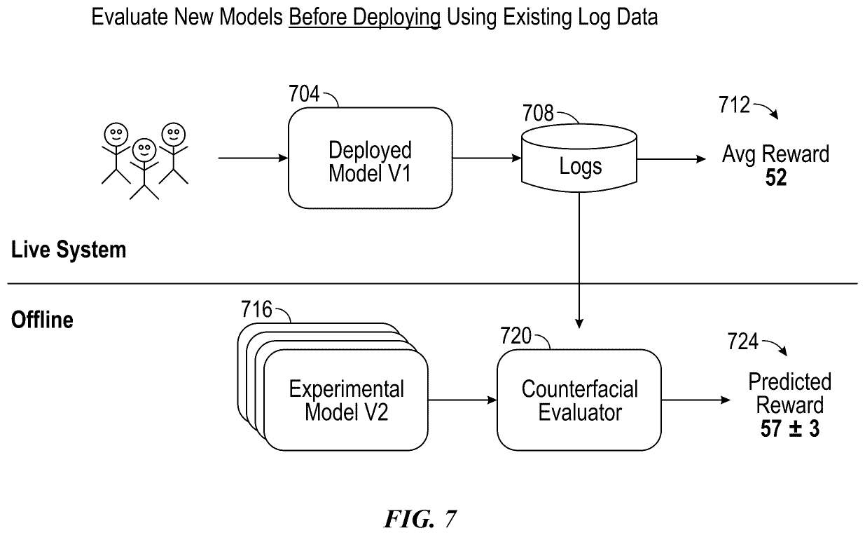

As described above, user feedback is not obtained in certain situations and therefore is not available to improve the model through training. In addition to the situation where a single answer is provided (and therefore effectively not clickable), feedback may be unavailable where a user chooses not to respond, when a user's browser is unable to present clickable options, and so on. This impairs propensity-based learning and off-policy and on-policy evaluation (described more fully below in conjunction with FIG. 7) as the unavailable feedback is often missing in a non-random way, resulting in biased learning data for training. FIG. 6 is a table showing the confidence score, a probability of being shown, and a probability of being clickable for six choices (A-F), in accordance with an example embodiment. As illustrated in FIG. 6, choice A is unclickable when presented alone. Although choice A is presented 100% of the time, it may only be clickable when presented with another option (such as choice B, C, or D) as a result of exploration or intervention (described more fully below). If the probability of choice B being clickable is 2% (as a result of exploration or intervention), the probability of choice C being clickable is 1% (as a result of exploration or intervention), and the probability of choice D being clickable is 1% (as a result of exploration or intervention), and if only one extra option is appended during exploration, then choice A will be clickable each time an option is presented or, in this example, 4% of the time. As a result, only 4% of the presentations of choice A will result in user feedback, leading to a potential bias of the obtained feedback as the 96% of presentations that are missing are generally not accurately reflected by the rest of the data, yet it has to be estimated based on only the 4% of the presentations. This is straightforward in this simple case but, for real traffic where the same user input may never repeat itself exactly, it is more difficult. One or more embodiments advantageously deal with this issue.

### Intervention Approach

In one example embodiment, to remove the bias to the propensity weighting created by the presence of non-random missing feedback, an intervention is performed. Initially, exploration, as described above, is performed to address selection bias (referred to herein as “base exploration”). A second layer of exploration (referred to herein as “feedback intervention”) is performed to ensure that additional feedback is obtained when it would otherwise be missing (due, for example, to the presentation of single answers) or where an insufficient amount of feedback is obtained (due, for example, to single answers that are presented with an insufficient amount of exploration of alternative options). This additional feedback may be obtained at random from the pool of events that would otherwise be missing feedback, or it may itself also be obtained in a biased way. Essentially, disambiguation is forced into the presentation where it would not otherwise occur (such as for single answers without exploration). In one example embodiment, a clarifying question, such as “Did you mean . . . ”, may be presented as a binary choice to obtain feedback on the presentation of a single answer. (Alternatively, the single answer may be made clickable to enable the user to indicate that the single answer is viewed, by the user, as the desired response.) In one example embodiment, the “intervention rate” (that is, the rate at which disambiguation is forcefully added) can be tuned independently versus the amount of base exploration. It is noted that single answers are often a high percentage of the conversation “traffic” with an AI assistant and are important to estimate with low variance. “Are you sure” checks are generally less harmful than adding an irrelevant or wrong answers to the higher confidence single answer.

### Propensity Calculations

In one example embodiment, propensities are computed independently, where P_{shown} is the propensity, or probability of the corresponding choice being shown to the user and P_{Feedback} is the probability that, if shown, the corresponding choice is enabled to receive feedback from the user (for example, the choice is clickable). The calculated probabilities can be combined appropriately for learning (model training) and the determination of unbiased off-policy estimates of the accepted answer rate, as described more fully below.

### Cost-Sensitive Learning

In one example embodiment, a cost value for training is computed using the following: propensity-based cost:

1/P_{shown}
and the missing-feedback-based cost:

1/P_{Feedback}

The overall cost is defined as:

$$cost = \frac{1}{{p}_{show}} \times \frac{1}{{p}_{Feedback}}$$

The overall cost is applied as a weight to the corresponding sample for the model training, thereby mitigating the bias created by the presence of biased feedback in the case where user feedback (such as clicks) provide the training examples. Samples are upweighted based on their probability of being shown and having feedback available reducing the training bias. In one example embodiment, the training data includes both clicks (positive examples) and non-clicks (negative examples). (Weights are applied in the same way as above, but for both positive and negative examples.)

### Off-Policy Evaluation/Estimation

FIG. 7 is a workflow of an example evaluation system for machine learning models, in accordance with an example embodiment. Propensities are pertinent to the off-policy (counterfactual) evaluation of FIG. 7. (Inverse propensity weighting is a well-known unbiased approach for performing off-policy estimation of new policies.) In one example embodiment, a live system 712 includes a deployed machine learning model 704 that generate data logs 708, such as logs of options presented to the user and feedback, such as clicks, obtained from the user. Based on the data logs 708, the reward generated by the deployed model 704 can be determined. For example, an average reward of 52 (such as a 52% click-rate) may be observed. In a conventional evaluation system, the computed reward would be inaccurate as there is missing log data as a result of the circumstances described above, such as the presentation of single answers.

In one example embodiment, a set of experimental machine learning models 716 are evaluated offline by a counterfactual evaluator 720 to generate predicted rewards. For example, a reward of 57+−3 is predicted based on the existing log data and the output of the set of experimental models 716. In a conventional evaluation system, the predicted reward would be inaccurate, since the propensities were determined using the incomplete log data generated as a result of the circumstances described above. The counterfactual evaluator 720 may be implemented as software running on a general-purpose computer; and as a neural network running on general purpose computer, running on one or more graphical processing units, using a hardware accelerator, and the like.

### Estimate Overall Accepted Answer Rate (On or Off-policy)

The accepted answer rate is defined as the fraction of incoming requests to which the system's response includes at least one relevant/correct answer. In one example embodiment, the accepted answer rate of the counterfactual evaluator 720 is defined as:

$$Accepted Answer Rate = {\sum }_{events} \frac{{p}_{shown}^{eval}}{{p}_{shown}^{log}} * \frac{1}{{p}_{Feedback}^{log}} * F ( user )$$

where p_{shown}^{log} is the propensity of the option being shown in the live system 712, p_{shown}^{eval} is the propensity of the option being shown in the off-policy system 724 that is being evaluated, p_{Feedback}^{log} is the probability that, if the logging/live system 712 shows the corresponding answer, the corresponding answer will have feedback available and F(user) is a numerical score representing the feedback from the user. In one example embodiment, user feedback is a click (or a lack of a click). In this case, the score would be given by F(user)=1 (if the user clicked on the option) and F(user)=0 (if the user didn't click on the option). It is worth noting that using click rate may not account for answers that “would have been clicked,” because they are correct, but were not clickable; one or more embodiments seek to use these as well.

### Estimate Accepted Answer Rate Restricted to Missing Feedback Subset

Intervention Approach: In the case that a system obtains additional feedback through an intervention, as described above, it is possible to extrapolate the additional feedback in an unbiased way to estimate the accepted answer rate for only those events which would not usually receive feedback from the logging policy that produced the responses actually shown to the user. This may be valuable in the case that the events missing feedback are of special interest, for example, if the events missing feedback are those events for which the system is especially confident in the correctness of its answer.

### Why Naïve Approaches Fail

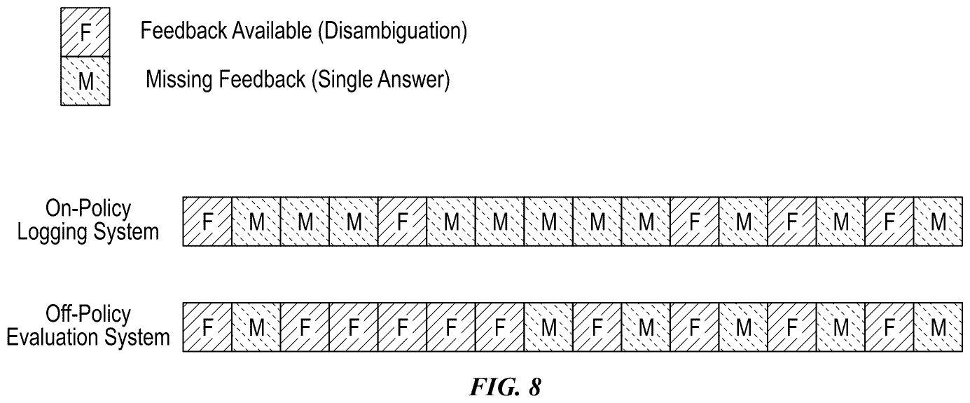

FIG. 8 illustrates the set of data points with missing feedback changes based on an example algorithm, in accordance with an example embodiment. A naive approach to estimate the performance/accepted answer rate of the off-policy (evaluation) system 724, based on the feedback from the (on-policy logging) live system 712, would only deal with the bias from showing a subset of possible options to the user (selection bias) but ignore the bias from missing feedback for options that are shown. This is bound to fail for any attempt at off-policy estimation because the subset of the data included in the estimate (from the logging policy) may be systematically different than the subset of the data that would have received feedback from the evaluation policy.

As an example, the logging policy might be generally much less likely to take actions that result in feedback (as illustrated in FIG. 8) compared to the evaluation policy. In this case, ignoring the bias from missing feedback would underestimate the accepted answer rate of the evaluation policy.

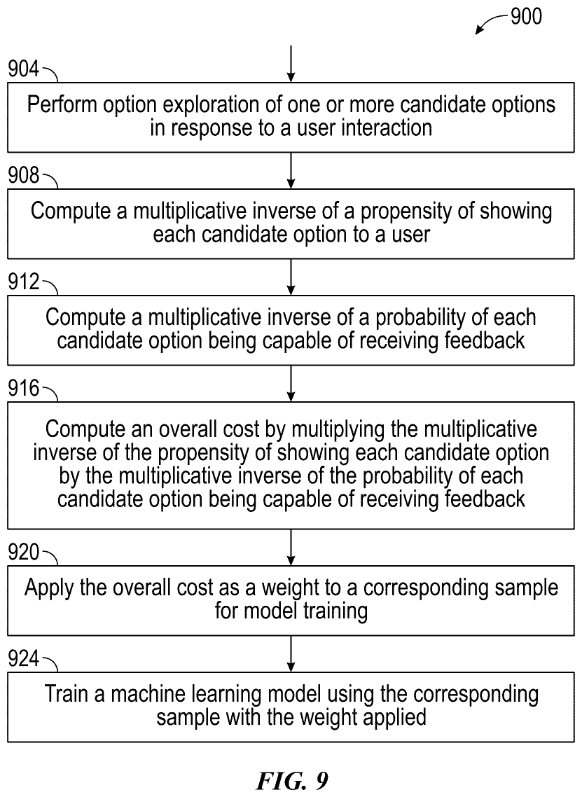

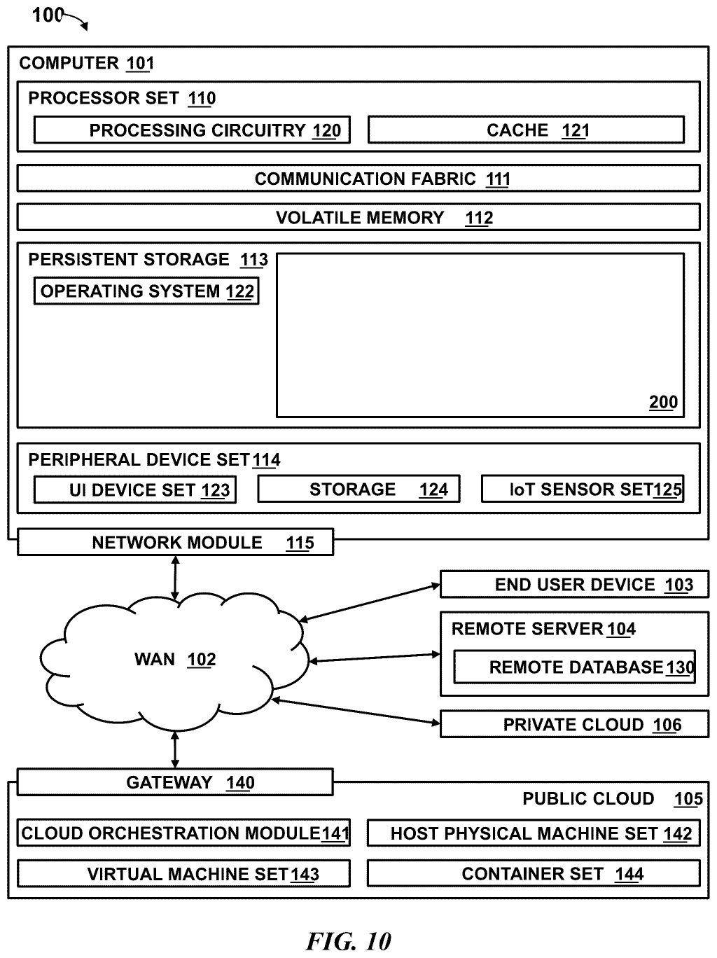

FIG. 9 is an example flowchart of an exemplary method 900, in accordance with an example embodiment. In one example embodiment, option exploration of one or more candidate options is performed in response to a user interaction (operation 904). A multiplicative inverse of a propensity p_{show} of showing each candidate option to a user is computed (operation 908) and a multiplicative inverse of a probability p_{Feedback} of each candidate option being capable of receiving feedback is computed (operation 912). An overall cost is computed by multiplying the multiplicative inverse of the propensity p_{show} of showing each candidate option by the multiplicative inverse of p_{Feedback} of each candidate option being able to receive feedback (operation 916). The overall cost is applied as a weight to a corresponding sample for model training (operation 920) and a machine learning model is trained using the corresponding sample with the weight applied (operation 924). One or more embodiments further include carrying out or otherwise facilitating deploying the trained model. At least some such embodiments further include carrying out or otherwise facilitating inferencing using the deployed model. Given the teachings herein, the skilled artisan will appreciate that one or more embodiments provide techniques for performing propensity-based learning or estimation in the presence of non-randomly missing feedback and/or for removing bias in propensity weighting created by a presence of non-random missing user feedback.

Given the discussion thus far, it will be appreciated that, in general terms, an exemplary method, according to an aspect of the invention, includes the operations of performing, using a hardware processor, option exploration of one or more candidate options in response to a user interaction (operation 904); computing, using the hardware processor, a multiplicative inverse of a propensity of showing each of the one or more candidate options to a user (operation 908); computing, using the hardware processor, a multiplicative inverse of a propensity of each of the one or more candidate options being able to receive feedback (operation 912); computing, using the hardware processor, an overall cost by multiplying the multiplicative inverse of the propensity of showing each of the one or more candidate options by the multiplicative inverse of propensity of each of the one or more candidate options being able to receive feedback (operation 916); and applying, using the hardware processor, the overall cost as a weight to a corresponding sample (e.g., for model training (operation 920) and/or evaluation).

In one example embodiment, a propensity-based estimation of a performance of the machine learning model is carried out based on inverse propensity scoring and/or inverse propensity weighting.

In one example embodiment, a propensity-based estimation of a performance of the machine learning model is carried out based on combining the computed propensities with model predictions using a doubly robust formula. For example, this combination can involve replacing the propensity value for each option in the doubly robust formula with the corrected value given by the product of the propensity and p_{Feedback}.

In one example embodiment, a machine learning model is trained using the corresponding sample with the weight applied.

In one example embodiment, the trained model is deployed.

In one example embodiment, inferencing is carried out using the deployed model.

In one example embodiment, the insufficient amount of user feedback is due to an inability to select an option when given single answer responses by a computerized assistant.

In one example embodiment, an additional layer of exploration occurs at a given intervention rate.

In one example embodiment, an additional layer of option exploration is used in response to obtaining an insufficient amount of user feedback during the user interaction.

In one example embodiment, the user feedback is one or more disambiguation clicks.

In one example embodiment, a propensity-based learning method of the training is cost-sensitive classification. Cost-sensitive classification is one non-limiting example of a propensity-based learning method; others are possible, such as contrastive models, oversampling of the important samples using the propensities, and the like. It is noted that the inverse-propensity scores are generally used as the weights. These can be any number greater than zero but, for training, the most important samples are the high value samples. In one example embodiment, the high value samples are oversampled by a factor corresponding to the sample's weights (for example, if the IPS score is 58.7, round the score to 59 and include 59 copies of this sample in the training data).

In one example embodiment, a propensity-based estimation of a performance of the machine learning model is carried out based on inverse propensity scoring and/or inverse propensity weighting. One or more embodiments compute probability-based weights, which can then be used, for example, in two ways: 1) for training models; and 2) for estimating the performance of models, systems, and the like.

In one example embodiment, a propensity-based estimation of a performance of the machine learning model is carried out based on combining the computed propensities with model predictions using a doubly robust formula. This combination involves replacing the propensity value for each option in the doubly robust formula with the corrected value given by the product of the propensity and the probability p_{Feedback}.

In one example embodiment, a minimum rate of obtaining user feedback from the user interaction is dynamically determined based on rules or models. This can be implemented as described in the section above entitled Intervention Approach. For example, the minimum rate is determined heuristically and the rate of feedback is increased by randomly presenting single answers in a manner capable of receiving feedback.

In one example embodiment, a model evaluation is performed by computing an accepted answer rate based on:

$$Accepted Answer Rate = {\sum }_{events} \frac{{p}_{shown}^{eval}}{{p}_{shown}^{log}} * \frac{1}{{p}_{Feedback}^{log}} * F ( user )$$

where p_{shown}^{log} is a propensity of the corresponding candidate option being shown in a live system 712, p_{shown}^{eval} is a propensity of the corresponding candidate option being shown in an off-policy system 724 being evaluated, p_{Feedback}^{log} is a probability that, if the live system 712 shows a corresponding answer, the corresponding answer has feedback available and F(user) is a numerical score representing feedback from the user.

In one example embodiment, the denominator p_{Feedback}^{log} is a probability that a corresponding candidate option is enabled to receive feedback given that it is shown.

In one aspect, a computer program product comprises one or more tangible computer-readable storage media and program instructions stored on at least one of the one or more tangible computer-readable storage media, the program instructions executable by a processor, the program instructions comprising performing option exploration of one or more candidate options in response to a user interaction (operation 904); computing a multiplicative inverse of a propensity of showing each of the one or more candidate options to a user (operation 908); computing a multiplicative inverse of a propensity of each of the one or more candidate options being able to receive feedback (operation 912); computing an overall cost by multiplying the multiplicative inverse of the propensity of showing each of the one or more candidate options by the multiplicative inverse of propensity of each of the one or more candidate options being able to receive feedback (operation 916); and applying the overall cost as a weight to a corresponding sample (e.g., for model training (operation 920) and/or evaluation).

In one aspect, a system comprises a memory and at least one processor, coupled to the memory, and operative to perform operations comprising performing option exploration of one or more candidate options in response to a user interaction (operation 904); computing a multiplicative inverse of a propensity of showing each of the one or more candidate options to a user (operation 908); computing a multiplicative inverse of a propensity of each of the one or more candidate options being able to receive feedback (operation 912); computing an overall cost by multiplying the multiplicative inverse of the propensity of showing each of the one or more candidate options by the multiplicative inverse of propensity of each of the one or more candidate options being able to receive feedback (operation 916); and applying the overall cost as a weight to a corresponding sample (e.g., for model training (operation 920) and/or evaluation).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a machine learning system 200 implementing aspects of unbiased machine learning and off-policy evaluation in the presence of biased feedback as disclosed herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing, using a hardware processor, option exploration of one or more candidate options in response to a user interaction;
computing, using the hardware processor, a multiplicative inverse of a propensity of showing each of the one or more candidate options to a user;
computing, using the hardware processor, a multiplicative inverse of a propensity of each of the one or more candidate options being able to receive feedback;
computing, using the hardware processor, an overall cost by multiplying the multiplicative inverse of the propensity of showing each of the one or more candidate options by the multiplicative inverse of propensity of each of the one or more candidate options being able to receive feedback; and
applying, using the hardware processor, the overall cost as a weight to a corresponding sample.

2. The method of claim 1, further comprising carrying out a propensity-based estimation of a performance of a machine learning model, with the weight applied, based on inverse propensity scoring and/or inverse propensity weighting.

3. The method of claim 1, further comprising carrying out a propensity-based estimation of a performance of a machine learning model, with the weight applied, based on combining the computed propensities with model predictions using a doubly robust formula.

4. The method of claim 1, further comprising training, using the hardware processor, a machine learning model using the corresponding sample with the weight applied.

5. The method of claim 4, further comprising deploying the trained model.

6. The method of claim 5, further comprising carrying out inferencing using the deployed model.

7. The method of claim 6, wherein the insufficient amount of user feedback is due to an inability to select an option when given single answer responses by a computerized assistant.

8. The method of claim 4, wherein an additional layer of exploration occurs at a given intervention rate.

9. The method of claim 4, further comprising using an additional layer of option exploration in response to obtaining an insufficient amount of user feedback during the user interaction.

10. The method of claim 4, wherein the user feedback is one or more disambiguation clicks.

11. The method of claim 4, wherein a propensity-based learning method of the training is cost-sensitive classification.

12. The method of claim 4, further comprising carrying out a propensity-based estimation of a performance of the machine learning model based on inverse propensity scoring and/or inverse propensity weighting.

13. The method of claim 4, further comprising carrying out a propensity-based estimation of a performance of the machine learning model based on combining the computed propensities with model predictions using a doubly robust formula.

14. The method of claim 4, further comprising dynamically determining a minimum rate of obtaining user feedback from the user interaction based on rules or models.

15. The method of claim 4, further comprising performing a model evaluation by computing an accepted answer rate based on:
$$Accepted Answer Rate = {\sum }_{events} \frac{{p}_{shown}^{eval}}{{p}_{shown}^{log}} * \frac{1}{{p}_{Feedback}^{log}} * F ( user )$$
where p_{shown}^{log} is a propensity of the corresponding candidate option being shown in a live system, p_{shown}^{eval} is a propensity of the corresponding candidate option being shown in an off-policy system being evaluated, p_{Feedback}^{log} is a probability that, if the live system 712 shows a corresponding answer, the corresponding answer has feedback available and F(user) is a numerical score representing feedback from the user.

16. The method of claim 15, wherein the denominator p_{Feedback}^{log} is a probability that a corresponding candidate option is enabled to receive feedback given that it is shown.

17. A computer program product, comprising:
one or more tangible computer-readable storage media and program instructions stored on at least one of the one or more tangible computer-readable storage media, the program instructions executable by a processor, the program instructions comprising:
performing option exploration of one or more candidate options in response to a user interaction;
computing a multiplicative inverse of a propensity of showing each of the one or more candidate options to a user;
computing a multiplicative inverse of a propensity of each of the one or more candidate options being able to receive feedback;
computing an overall cost by multiplying the multiplicative inverse of the propensity of showing each of the one or more candidate options by the multiplicative inverse of propensity of each of the one or more candidate options being able to receive feedback;
applying the overall cost as a weight to a corresponding sample.

18. A system comprising:
a memory; and
at least one processor, coupled to said memory, and operative to perform operations comprising:
performing option exploration of one or more candidate options in response to a user interaction;
computing a multiplicative inverse of a propensity of showing each of the one or more candidate options to a user;
computing a multiplicative inverse of a propensity of each of the one or more candidate options being able to receive feedback;
computing an overall cost by multiplying the multiplicative inverse of the propensity of showing each of the one or more candidate options by the multiplicative inverse of propensity of each of the one or more candidate options being able to receive feedback;
applying the overall cost as a weight to a corresponding sample.

19. The system of claim 18, the operations further comprising carrying out a propensity-based estimation of a performance of the machine learning model, with the weight applied, based on inverse propensity scoring and/or inverse propensity weighting.

20. The system of claim 18, the operations further comprising carrying out a propensity-based estimation of a performance of the machine learning model, with the weight applied, based on combining the computed propensities with model predictions using a doubly robust formula.

21. The system of claim 18, the operations further comprising training a machine learning model using the corresponding sample with the weight applied.
